(19) United States
(12) Patent Application Publication
(10) Pub. No.: US 2016/0003445 A1
(43) Pub. Date: Jan. 7, 2016

(54) ARTISTIC LIGHTING MODULE AND METHOD FOR MANUFACTURING THE SAME

(71) Applicant: Che-Chang HU, Tainan City (TW)

(72) Inventor: Che-Chang HU, Tainan City (TW)

(21) Appl. No.: 14/323,632

(22) Filed: Jul. 3, 2014

(51) Int. Cl. F21V 7/22; F21K 99/00; F21S 8/00; F21V 9/16; F21S 8/10

(52) U.S. Cl. CPC F21V 7/22; F21V 9/16; F21S 48/00; F21S 8/033; F21K 9/90; F21W 2121/004

(57) ABSTRACT

An artistic lighting module and a method for manufacturing the same are disclosed. The artistic lighting module comprises at least one transparent panel, at least one light source, and a reflective layer. The light source is disposed at one end of the transparent panel, and the reflecting layer has an artistic pattern. The light rays inputted into the transparent panel are reflected by the reflective layer and outputted through the second surface, such that a lighting pattern corresponding to the artistic pattern is formed on a second surface of transparent panel.

### FIELD OF THE INVENTION

The present invention relates to an artistic lighting module and a method for manufacturing the same, and more particularly to an artistic lighting module with an artistic effect for architectural and vehicle industries.

### BACKGROUND OF THE INVENTION

At present, transparent panels, such as glass sheets, are well used in building structures. Taking glass curtain walls for example, glass curtain walls are made of glass sheets. Construction technology often employs unitized glass curtain walls that are anchored to the building structure. A glass curtain wall is a lightweight exterior cladding that is connected to the building structure, usually from floor to floor. It can provide a variety of exterior appearances. Glass curtain walls are designed to accommodate structural deflections, control wind-driven rain and air leakage, minimize the effects of solar radiation, and provide for low maintenance long term performance.

In addition, glass sheets can also be used for windows. Vehicle and building windows that transmit incident light are desired by many, and are currently commercially available to control the sunlight intrusion into vehicles and buildings.

However, most curtain walls or windows in a building or a room lack any artistic effect. It would be desirable to provide a device or module with a transparent panel, such as a curtain wall or window in the building or vehicle, for improving the artistic or decorative effect.

### SUMMARY OF THE INVENTION

A primary object of the present invention is to provide an artistic lighting module, wherein the artistic lighting module comprises: at least one transparent panel having a first surface and a second surface, wherein the first surface is opposite the second surface; at least one light source disposed at one end of the transparent panel and positioned between the first surface and the second surface, wherein light rays emitted from the light source are inputted into the transparent panel; and a reflective layer coated on the first surface of the transparent panel, wherein the reflecting layer has an artistic pattern, and the light rays inputted into the transparent panel are reflected by the reflective layer and outputted through the second surface, such that a lighting pattern corresponding to the artistic pattern is formed on the second surface of the transparent panel.

A secondary object of the present invention is to provide a method for manufacturing an artistic lighting module, wherein the method comprises: providing at least one transparent panel, wherein the transparent panel has a first surface and a second surface, and the first surface is opposite the second surface; providing at least one light source, wherein the light source is disposed at one end of the transparent panel and positioned between the first surface and the second surface, and light rays emitted from the light source are inputted into the transparent panel; and coating a reflective layer on the first surface of the transparent panel, wherein the reflective layer has an artistic pattern, and the light rays inputted into the transparent panel are reflected by the reflective layer and outputted through the second surface, such that a lighting pattern corresponding to the artistic pattern is formed on the second surface of the transparent panel.

A further object of the present invention is to provide an artistic lighting module for a vehicle or a building, wherein the artistic lighting module comprises: at least one transparent panel having a first surface and a second surface, wherein the first surface is opposite the second surface; at least one light source disposed at one end of the transparent panel and positioned between the first surface and the second surface, wherein light rays emitted from the light source are inputted into the transparent panel; and a reflective layer coated on the first surface of the transparent panel, wherein the reflecting layer has an artistic pattern, and the light rays inputted into the transparent panel are reflected by the reflective layer and outputted through the second surface, such that a lighting pattern corresponding to the artistic pattern is formed on the second surface of the transparent panel. The light source and a power source are embedded in a frame or a wall of the building or vehicle, and only the first surface and the second surface of the transparent panel are exposed outside.

In one embodiment of the present invention, the artistic lighting module acts as an architectural window, a curtain-wall, a glass door, a partition, a mirror, a sun roof, or a moon roof. In some embodiments, the artistic lighting module of the present invention may be a part of a building or a vehicle.

In one embodiment of the present invention, the transparent panel is made of a glass, a plastic material, a photo-curable resin, a polymethylmethacrylate (PMMA), or a polycarbonate (PC).

In one embodiment of the present invention, the transparent panel is a glass panel, such as a strengthened glass for high structure strength.

In one embodiment of the present invention, when the artistic lighting module is employed as a window or curtain-wall, the first surface of the transparent panel faces outdoors, and the second surface faces indoors.

In one embodiment of the present invention, when the artistic lighting module is employed as a window or curtain-wall, the first surface of the transparent panel faces indoors, and the second surface faces outdoors.

In one embodiment of the present invention, the light source and a power source are embedded in a frame or a wall of a building or a vehicle, and only the first surface and the second surface of the transparent panel are exposed outside.

In one embodiment of the present invention, the light rays emitted from the light source have one or more than one color.

In another embodiment, the one or more colors of the light rays of the at least one light source are variable for improving the artistic effect.

In one embodiment of the present invention, the light source is a cold cathode fluorescent lamp (CCFL), a hot cathode fluorescent lamp (HCFL), a light emitting diode (LED), an organic light emitting diode (OLED), an electro-luminescence (EL) device, a light bar, an electrode-less lamp, a halogen lamp, a high Intensity discharge (HID) lamp, an incandescent lamp, or any combination thereof.

In one embodiment of the present invention, the artistic lighting module comprises more than one light sources, and the more than one light sources are disposed at one end or more than one ends for providing the light rays into the transparent panel.

In varied embodiments of the present invention, the artistic pattern of the reflective layer and the lighting pattern comprise words, a mark, a trademark and/or an indication sign. Therefore, the artistic pattern or the lighting pattern of the artistic lighting module can be used to show an artistic picture, words, a mark, a trademark, and/or an indication sign.

In varied embodiments of the present invention, the artistic pattern is only formed on a partial area of the first surface of the transparent panel.

In one embodiment of the present invention, an area of the lighting pattern is less than 75% of an area of the second surface for making the artistic effect of the lighting pattern more prominent.

In some embodiments of the present invention, an area of the lighting pattern is less than 50% of an area of the second surface for making the artistic effect of the lighting pattern more prominent.

In one embodiment of the present invention, the reflective layer is coated by a printing machine, and the artistic pattern of the printing machine is predetermined by an inputted picture, and the inputted picture is inputted into the printing machine before coating the reflective layer on the first surface of the transparent panel.

In one embodiment of the present invention, the printing machine is an ink-jet printing machine or a roll-to-roll printing machine.

In one embodiment of the present invention, the inputted picture comprises an artistic picture, words, a mark, a trademark, and/or an indication sign, and the inputted picture is inputted into the printing machine through a computer.

In varied embodiments of the present invention, when the artistic lighting module of the present invention is disposed in/on a vehicle or building, the transparent panel is in a standing state, and the first surface and/or the second surface are exposed outside.

In varied embodiments of the present invention, when the light source is turned off, the artistic pattern of the reflective layer has a first artistic effect. When the light source is turned on, the artistic pattern of the reflective layer has a second artistic effect different from the first artistic effect.

In one embodiment of the present invention, the reflective layer with the artistic pattern has one or more than one colors for forming the first artistic effect.

In one embodiment of the present invention, the light rays of the at least one light source have one or more colors for forming the second artistic effect. Moreover, the one or more colors of the light rays of the at least one light source can be variable.

In one embodiment of the present invention, the at least one transparent panel comprises two transparent panels, and the at least one light source comprises at least two light sources disposed at ends of the transparent panels for emitting light rays into the transparent panels, respectively. The reflective layer is formed between the two transparent panels and in contact with the first surfaces of the transparent panels. When the light sources are turned on, the light rays from the light sources are reflected by the reflective layer and outputted through the second surfaces, respectively, thereby forming the lighting patterns on the second surfaces.

In one embodiment of the present invention, reflective particles are mixed in the reflective layer on the transparent panel. With the reflective particles, a reflective efficiency of the reflective layer can be improved.

In one embodiment of the present invention, phosphors are mixed in the reflective layer on the transparent panel, and the phosphors are excited by the light rays from the at least light source and emit light of varied colors, thereby improving the artistic effect.

In one embodiment of the present invention, the artistic lighting module is disposed on a wall of the building or vehicle, and only the second surface of the artistic lighting module is exposed outside.

In one embodiment of the present invention, a cover sheet covers the reflective layer and the second surface of the transparent panel, and the reflective layer is formed between the transparent panel and the cover sheet. The cover sheet may be transparent, opaque, or translucent.

In one embodiment, the cover sheet may be a strengthened glass for protecting the transparent panel and the reflective layer.

The artistic lighting module of the present invention can be employed in architectural and vehicle industries. For example, the artistic lighting module can act as an architectural window, a curtain-wall, a glass door, a partition, a mirror, a sun roof or a moon roof. Moreover, the artistic lighting module of the present invention may be a part of a building or a vehicle. The artistic lighting module of the present invention can provide the at least one lighting pattern for showing an artistic picture, words, a mark, a trademark, and/or an indication sign, and thus the artistic lighting module can be used in the building or vehicle for decoration, advertisement, and/or indication. Furthermore, with the use of the method for manufacturing the artistic lighting module of the present invention, the reflective layer with any pattern and/or sign can be easily coated on the transparent panel for forming the lighting pattern. In addition, when the light source of the artistic lighting module is turned on, the artistic lighting module can provide indirect lighting. Moreover, the reflective layer of the artistic lighting module can filter out the infrared spectrum by reflection or absorption or a combination of both.

The structure and the technical means adopted by the present invention to achieve the above-mentioned and other objects can be best understood by referring to the following detailed description of the preferred embodiments and the accompanying drawings:

### DESCRIPTION OF THE DRAWINGS

FIG. 1 is a schematic diagram showing an artistic lighting module according to one embodiment of the present invention;

FIG. 2 is a schematic diagram showing a lighting pattern of the artistic lighting module;

FIG. 3 is a cross-sectional view of the artistic lighting module according to one embodiment of the present invention;

FIG. 4 is a schematic diagram showing an artistic lighting module according to one embodiment of the present invention;

FIG. 5 is a schematic diagram showing a printing machine and the artistic lighting module according to one embodiment of the present invention;

FIG. 6 is a flowchart of a method for manufacturing the artistic lighting module according to varied embodiments of the present invention;

FIG. 7 is a schematic diagram showing an artistic lighting module according to one embodiment of the present invention;

FIG. 8 is a schematic diagram showing a reflective layer on the transparent panel according to one embodiment of the present invention; and

FIG. 9 is a schematic diagram showing an artistic lighting module according to one embodiment of the present invention; and

FIG. 10 is a schematic diagram showing an artistic lighting module according to one embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings are ease of understanding and ease of description, but the present invention is not limited thereto.

In the drawings, the thickness of layers, films, panels, regions, etc., are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

In addition, in the specification, unless explicitly described to the contrary, the word “comprise” and variations such as “comprises” or “comprising” will be understood to imply the inclusion of stated elements but not the exclusion of any other elements. Furthermore, in the specification, “on” implies being positioned above or below a target element and does not imply being necessarily positioned on the top with respect to the direction of gravitational pull.

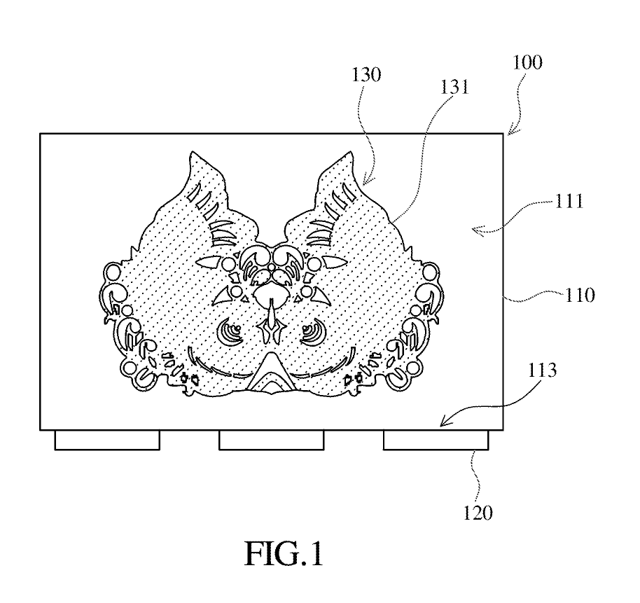

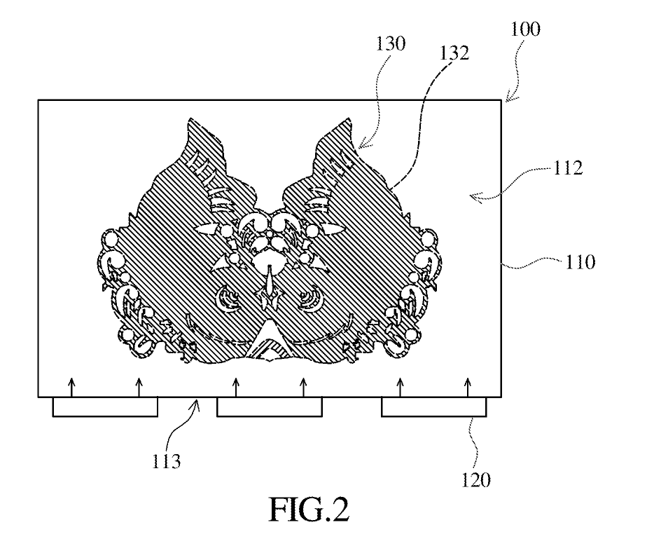

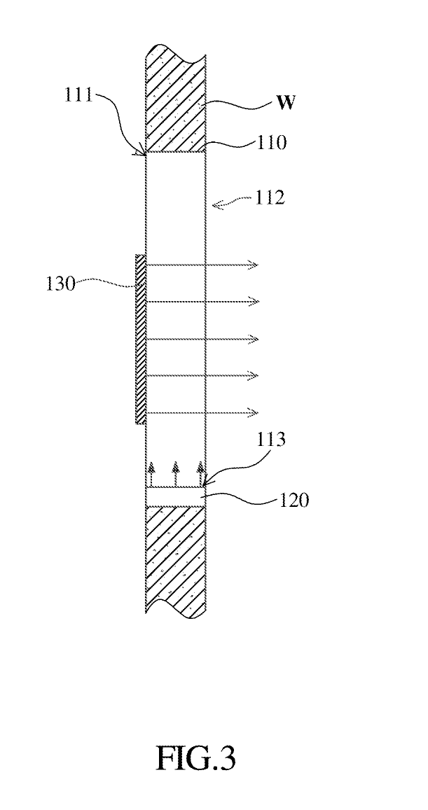

Referring to FIGS. 1 to 3, FIG. 1 is a schematic diagram showing an artistic lighting module according to one embodiment of the present invention, FIG. 2 is a schematic diagram showing a lighting pattern of the artistic lighting module, and FIG. 3 is a cross-sectional view of the artistic lighting module. The artistic lighting module 100 can be employed in architectural and vehicle industries. In specific applications, the artistic lighting module 100 may be arranged in or act as an architectural window, a curtain wall, a glass door, a partition, a mirror, a sun roof, or a moon roof. That is, in some embodiments, the artistic lighting module of the present invention may be a part of a building or a vehicle. The artistic lighting module 100 can comprise at least one transparent panel 110, at least one light source 120, and a reflective layer 130. The at least one light source 120 is disposed at one end of the transparent panel 110 for emitting light rays into the transparent panel 110. The reflective layer 130 is formed on one surface of the transparent panel 110 for forming a lighting pattern 132 of an artistic pattern or effect.

Referring to FIGS. 1 to 3 again, the transparent panel 110 may be made of a glass, a plastic material, a photo-curable resin, a polymethylmethacrylate (PMMA), or a polycarbonate (PC). In one embodiment, the transparent panel 110 may be a glass panel, such as a strengthened glass, for high structure strength. The transparent panel 110 has a first surface 111, a second surface 112, and a light-incident surface 113. The first surface 111 and the second surface 112 have the largest areas of the transparent panel 110, and the first surface 111 is opposite the second surface 112. For example, when the artistic lighting module 100 is employed as the window or curtain wall, the first surface 111 of the transparent panel 110 can face outdoors, and the second surface 112 can face indoors, but is not limited thereto. In another case, the second surface 112 of the transparent panel 110 can face outdoors to show the lighting pattern for decoration or advertisement.

Referring to FIGS. 1 and 3 again, the light-incident surface 113 is formed on at least one end of the transparent panel 110 and faces the light source 120 for allowing the light rays emitted from the light source 120 to be inputted into the transparent panel 110. In practice, when the artistic lighting module 100 is employed in the building or vehicle, the light-incident surface 113 of the transparent panel 110, the light source 120, and a power source (or electrical wires) are embedded in a wall W or a frame of the building or vehicle, and thus only the first surface 111 and the second surface 112 are exposed outside.

Referring to FIGS. 1 to 3 again, the light source 120 is disposed at one end of the transparent panel 110 and positioned between the first surface 111 and the second surface 112, wherein the light rays emitted from the light source 120 are inputted into the transparent panel 110, and the light rays emitted from the light source 120 can have one or more than one colors. The light source 120 may be, for example, a cold cathode fluorescent lamp (CCFL), a hot cathode fluorescent lamp (HCFL), a light emitting diode (LED), an organic light emitting diode (OLED), an electro-luminescence (EL) device, a light bar, an electrode-less lamp, a halogen lamp, a high Intensity discharge (HID) lamp, an incandescent lamp, or any combination thereof.

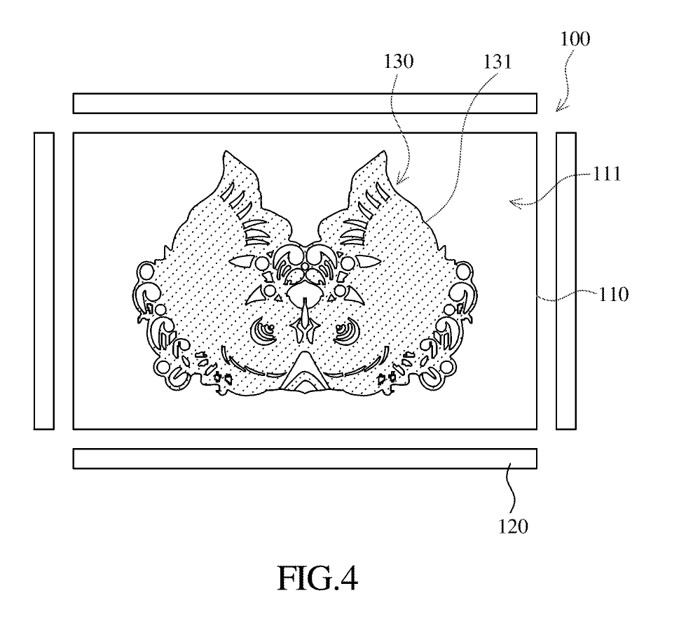

FIG. 4 is a schematic diagram showing an artistic lighting module according to one embodiment of the present invention. In one embodiment, the artistic lighting module 100 can comprise more than one light sources 120, and the more than one light sources 120 can be disposed at one end or more than one ends for providing the light rays into the transparent panel 110.

In another embodiment, the one or more colors of the light rays of the at least one light source 120 can be variable for improving the artistic effect.

Referring to FIGS. 1 to 3 again, the reflective layer 130 can be coated on the first surface 111 of the transparent panel 110, wherein the reflective layer 130 has an artistic pattern 131, and the light rays inputted into the transparent panel 110 are reflected by the reflective layer 130 and outputted through the second surface 112, such that the lighting pattern 132 corresponding to the artistic pattern 131 can be formed on the second surface 112 of transparent panel 110. The reflective layer 130 may be made of a highly reflective material, such as Ag, Al, Au, Cr, Cu, In, Ir, Ni, Pt, Re, Rh, Sn, Ta, W, Mn, an alloy of any combination thereof, or a white reflective paint with etiolation-resistant and heat-resistant properties for reflecting the light rays.

Referring to FIGS. 1 to 3 again, the artistic pattern 131 and the lighting pattern 132 are simultaneously identical. The artistic pattern 131 of the reflective layer 130 can be identical to a specific picture or a static image with an artistic effect. Moreover, the artistic pattern 131 of the reflective layer 130 can comprise words, a mark, a trademark, and/or an indication sign. That is, the artistic pattern 131 of the reflective layer 130 preferably has meanings to a viewer. Therefore, the artistic pattern 131 or the lighting pattern 132 of the artistic lighting module 100 can be used to show an artistic picture, words, a mark, a trademark, and/or an indication sign.

Referring to FIGS. 1 and 3 again, to make the artistic effect of the artistic pattern 131 or the lighting pattern 132 more clear, the artistic pattern 131 is only formed on a partial area of the first surface 111 of the transparent panel 110. That is, an area of the artistic pattern 131 or the lighting pattern 132 is at least less than an area of the first surface 111 or the second surface 112. In one embodiment, the area of the lighting pattern 132 can be less than 75% of the area of the second surface 112 for making the artistic effect of the lighting pattern 132 more clear. For some applications, the area of the lighting pattern 132 may be less than 50% of the area of the second surface 112 for a better artistic effect.

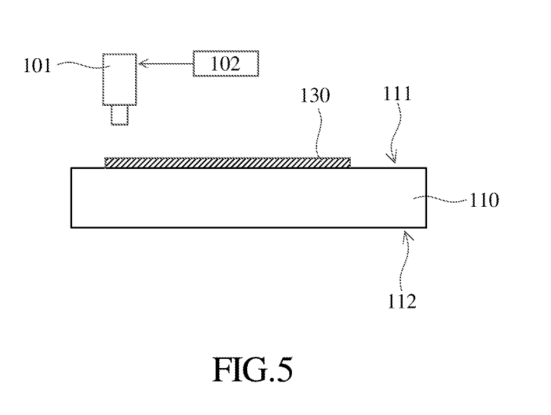

FIG. 5 illustrates a schematic diagram showing a printing machine and the artistic lighting module according to one embodiment of the present invention. In one embodiment, the reflective layer 130 is coated by a printing machine 101, such as an ink-jet printing machine or a roll-to-roll printing machine, and the artistic pattern 131 of the printing machine 101 is predetermined by an inputted picture 102. The inputted picture 102 is inputted into the printing machine 101 before coating the reflective layer 130 on the first surface 111 of the transparent panel 110. The inputted picture 102 can comprise an artistic picture, words, a mark, a trademark, and/or an indication sign. Therefore, the reflective layer 130 with the artistic pattern 131 can be easily coated on the transparent panel 110 by the printing machine 101 and the inputted picture 102. In this case, the inputted picture 102 can be inputted into the printing machine 101 through a computer (not shown).

In practice, as shown in FIG. 3, when the artistic lighting module 100 of the present invention is disposed in/on a vehicle or building, the transparent panel 110, the transparent panel 110 is in a standing state, and only the first surface 111 and portions of the second surface 112 are exposed outside.

As shown in FIG. 1, when the light source 120 of the artistic lighting module 100 is turned off, there are no light rays emitted from the light source 120, and the artistic pattern 131 of the reflective layer 130 can be shown on the first surface 111 or the second surface 112 of the transparent panel 110. At this time, especially in the day, the artistic pattern 131 of the reflective layer 130 can have a first artistic effect. For example, the reflective layer 130 with the artistic pattern 131 can have one or more than one colors for forming the first artistic effect.

As shown in FIG. 2, when the light source 120 of the artistic lighting module 100 is turned on, the light source 120 emits the light rays into the transparent panel 110, and the light rays from the light source 120 are reflected by the reflective layer 130 and outputted through the second surface 112, thereby forming the lighting pattern on the second surface 112. At this time, especially at night, the artistic pattern 131 of the reflective layer 130 can have a second artistic effect different to the first artistic effect. For example, the light rays of the at least one light source 120 can have one or more colors for forming the second artistic effect. Moreover, the one or more colors of the light rays of the at least one light source 120 can be variable.

In practice, due to the light rays of the lighting pattern 132 of the lighting and artistic effect, the second artistic effect can be more prominent than the first artistic effect. That is, the artistic lighting module 100 of the present invention can have varied artistic effects.

With the use of the artistic pattern 131 of the reflective layer 130, the lighting pattern 132 can be formed on the second surface 112 of the artistic lighting module 100, so as to show artistic pictures, words, marks, trademarks, indication signs, and/or any other signs. Therefore, the artistic lighting module 100 of the present invention can be used for decoration, advertisement, or indication. In addition, when the light source 120 of the artistic lighting module 100 is turned on, the artistic lighting module 100 can provide the light rays, thereby being allowed to provide indirect lighting.

Moreover, the infrared spectrum of sunlight radiation can be absorbed by materials that make up the interior of a vehicle or building, and is a very significant portion of heat converted from absorption of light. In the present invention, the reflective layer 130 of the artistic lighting module 100 can filter out the infrared spectrum by reflection or absorption or a combination of both. The filtering of this infrared spectrum can reduce the temperature rise of the interior of a vehicle or building due to this converted heat, and reduce the energy and cost for cooling a vehicle or building on a hot day.

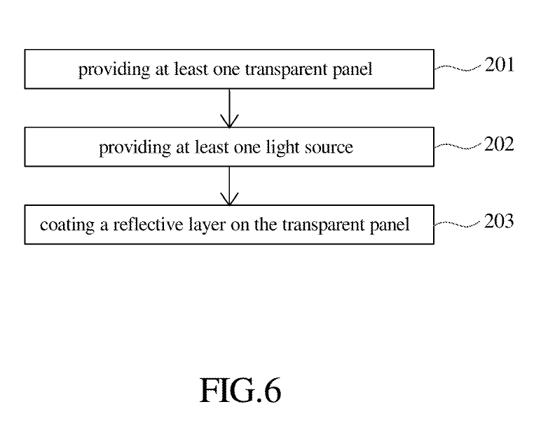

FIG. 6 is a flowchart of a method for manufacturing the artistic lighting module according to varied embodiments of the present invention. The method of the present invention for manufacturing the artistic lighting module 100 comprises the following steps: providing the at least one transparent panel 110 (step 201); providing the at least one light source 120, wherein the light source 120 is disposed at one end of the transparent panel 110 and positioned between the first surface 111 and the second surface 112 (step 202); and coating the reflective layer 130 on the first surface 111 of the transparent panel 110 (step 203).

In the step 203 of the present embodiment, when coating the reflective layer 130, the reflective layer 130 is coated by a printing machine 101, such as an ink-jet printing machine, a roll-to-roll printing machine or any other printing machine, and the artistic pattern 131 of the printing machine 101 is predetermined by an inputted picture 102. The inputted picture 102 is inputted into the printing machine 101 before coating the reflective layer 130 on the reflective layer 130 on the first surface 111 of the transparent panel 110. In this case, the inputted picture 102 can be inputted into the printing machine 101 through a computer (not shown). The inputted picture 102 can comprise an artistic picture, words, a mark, a trademark, and/or an indication sign. Therefore, the reflective layer 130 with the artistic pattern 131 can be easily coated on the transparent panel 110 by the printing machine 101 and the inputted picture 102, and any pattern and/or sign can be formed very easily by the printing machine 101 and the inputted picture 102.

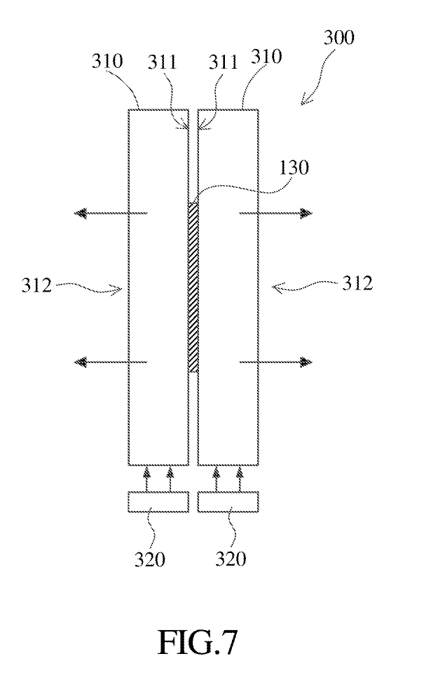

FIG. 7 illustrates a schematic diagram showing an artistic lighting module according to one embodiment of the present invention. In one embodiment, the artistic lighting module 300 comprises two transparent panels 310, and the two transparent panels 310 are stacked together. At least two light sources 320 are disposed at ends of the transparent panels 310 for emitting light rays into the transparent panels 310, respectively. The reflective layer 330 is formed between the two transparent panels 310 and in contact with the first surfaces 311 of the transparent panels 310. When the light sources 320 of the artistic lighting module 300 are turned on, the light sources 320 emit the light rays into the transparent panels 310, and the light rays from the light sources 320 are reflected by the reflective layer 330 and outputted through the second surfaces 312, respectively, thereby forming the lighting patterns on the second surfaces 312. Therefore, the artistic lighting module 300 can provide lighting patterns on two opposite sides (the second surfaces 312) thereof, for improving the decoration, advertisement, and/or indication. In practice, the light sources 320 and a power source (or electrical wires) are embedded in a frame or a wall of a building or a vehicle, and thus only the two second surfaces 312 of the artistic lighting module 300 are exposed outside.

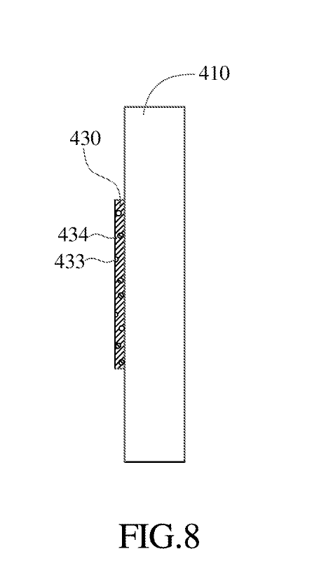

FIG. 8 illustrates a schematic diagram showing a reflective layer on the transparent panel according to one embodiment of the present invention. In one embodiment, reflective particles 433 and/or phosphors 434 can be mixed in the reflective layer 430 on the transparent panel 410. With the reflective particles 433, a reflective efficiency of the reflective layer 430 can be improved. The phosphors 434 can be excited by the light rays from the at least light source and emit light of varied colors, thereby improving the artistic effect.

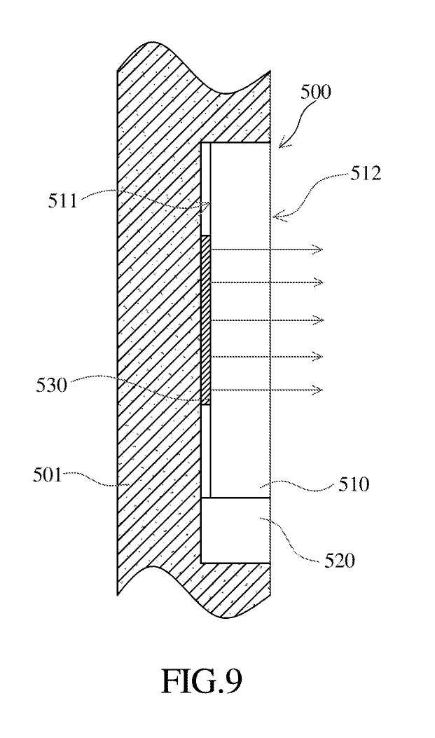

FIG. 9 illustrates a schematic diagram showing an artistic lighting module according to one embodiment of the present. In one embodiment, the artistic lighting module 500 can be disposed on a wall 501 of the building or vehicle for decoration, advertisement, and/or indication. In this case, the reflective layer 530 is formed between the first surface 511 of the transparent panel 510 and the wall 501. When the light source 520 of the artistic lighting module 500 are turned on, the light source 520 emits the light rays into the transparent panel 510, and the light rays from the light source 520 are reflected by the reflective layer 530 and outputted through the second surface 512, thereby forming the lighting pattern on the second surface 512. In practice, the light source 520 and a power source (or electrical wires) are embedded in a frame or the wall 501 of the building or vehicle, and thus only the second surface 512 of the artistic lighting module 500 is exposed outside.

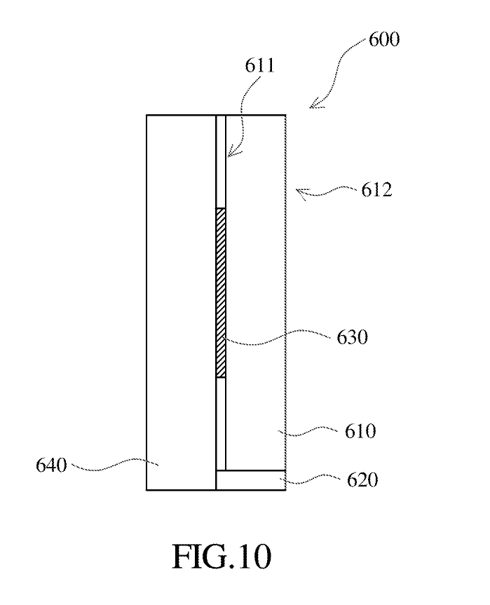

FIG. 10 illustrates a schematic diagram showing an artistic lighting module according to one embodiment of the present invention. In one embodiment, the artistic lighting module 600 further comprises a transparent panel 610, at least one light source 620, and a reflective layer 630 and a cover sheet 640. The transparent panel 610 and the cover sheet 640 are stacked together. The least one light source 620 is disposed at one end of the transparent panel 610 for emitting light rays into the transparent panel 610. The reflective layer 630 is formed between the transparent panel 610 and the cover sheet 640, and in contact with the first surfaces 611 of the transparent panels 610. When the light source 620 of the artistic lighting module 600 is turned on, the light source 620 emits the light rays into the transparent panel 610, and the light rays are reflected by the reflective layer 630 and outputted through the second surface 612, thereby forming the lighting patterns on the second surface 612. The cover sheet 640 is configured to cover the reflective layer 630 and the second surface 612 of the transparent panel 610. The cover sheet 640 may be transparent, opaque, or translucent. In one embodiment, the cover sheet 640 may be a strengthened glass for protecting the transparent panel 610 and the reflective layer 630.

As described above, the artistic lighting module of the present invention can be employed in architectural and vehicle industries, and can act as an architectural window, a curtain wall, a glass door, a partition, a mirror, a sun roof, a moon roof. Moreover, in some embodiments, the artistic lighting module of the present invention can be a part of a building or a vehicle. The artistic lighting module of the present invention can provide the at least one lighting pattern with an artistic picture, words, a mark, a trademark, and/or an indication sign, and thus the artistic lighting module can be used in the building or vehicle for decoration, advertisement, and/or indication. Furthermore, with the use of the method for manufacturing the artistic lighting module of the present invention, the reflective layer with any pattern and/or sign can be easily coated on the transparent panel for forming the lighting pattern. In addition, when the light source of the artistic lighting module is turned on, the artistic lighting module can provide the indirect lighting. Moreover, the reflective layer of the artistic lighting module can filter out the infrared spectrum by reflection or absorption or a combination of both.

The present invention has been described with preferred embodiments thereof, and it is understood that many changes and modifications to the described embodiments can be carried out without departing from the scope and the spirit of the invention that is intended to be limited only by the appended claims.

1. An artistic lighting module, comprising:
at least one transparent panel having a first surface and a second surface, wherein the first surface is opposite the second surface;
at least one light source disposed at one end of the transparent panel and positioned between the first surface and the second surface, wherein light rays emitted from the light source are inputted into the transparent panel; and
a reflective layer coated on the first surface of the transparent panel, wherein the reflecting layer has an artistic pattern, and the light rays inputted into the transparent panel are reflected by the reflective layer and outputted through the second surface, such that a lighting pattern corresponding to the artistic pattern is formed on the second surface of transparent panel.

2. The artistic lighting module according to claim 1, wherein the artistic lighting module acts as an architectural window, a curtain wall, a glass door, a partition, a mirror, a sun roof, or a moon roof.

3. The artistic lighting module according to claim 1, wherein the artistic lighting module is employed as a window or a curtain wall of a building or a vehicle, and the first surface of the transparent panel faces outdoors, and the second surface faces indoors.

4. The artistic lighting module according to claim 1, wherein the light source and a power source are embedded in a frame or a wall of a building or a vehicle, and only the first surface and the second surface of the transparent panel are exposed outside.

5. The artistic lighting module according to claim 1, wherein the lighting pattern comprises words, a mark, a trademark, and/or an indication sign.

6. The artistic lighting module according to claim 1, wherein an area of the lighting pattern is less than 75% of an area of the second surface.

7. The artistic lighting module according to claim 6, wherein an area of the lighting pattern is less than 50% of an area of the second surface.

8. The artistic lighting module according to claim 1, wherein the reflective layer is coated by a printing machine, and the artistic pattern of the printing machine is predetermined by an inputted picture, and the inputted picture is inputted into the printing machine before coating the reflective layer on the first surface of the transparent panel.

9. The artistic lighting module according to claim 7, wherein the inputted picture comprises an artistic picture, words, a mark, a trademark, and/or an indication sign, and the inputted picture is inputted into the printing machine through a computer.

10. The artistic lighting module according to claim 7, wherein the printing machine is an ink-jet printing machine or a roll-to-roll printing machine

11. The artistic lighting module according to claim 1, wherein the at least one transparent panel comprises two transparent panels, and the at least one light source comprises at least two light sources disposed at ends of the transparent panels for emitting light rays into the transparent panels, respectively, and the reflective layer is formed between the two transparent panels and in contact with the first surfaces of the transparent panels.

12. The artistic lighting module according to claim 1, wherein reflective particles are mixed in the reflective layer on the transparent panel.

13. The artistic lighting module according to claim 1, wherein phosphors are mixed in the reflective layer on the transparent panel, and the phosphors are excited by the light rays from the at least light source and emit light of varied colors.

14. The artistic lighting module according to claim 1, wherein the artistic lighting module is disposed on a wall of the building or vehicle, and only the second surface of the artistic lighting module is exposed outside.

15. The artistic lighting module according to claim 1, wherein the artistic lighting module of the present invention is disposed in/on a vehicle or building, and the transparent panel is in a standing state, and the first surface and/or the second surface are exposed outside.

16. The artistic lighting module according to claim 1, wherein colors of the light rays of the at least one light source are variable.

17. The artistic lighting module according to claim 1, wherein a cover sheet covers the reflective layer and the second surface of the transparent panel, and the reflective layer is formed between the transparent panel and the cover sheet.

18. A method for manufacturing an artistic lighting module, comprising:
providing at least one transparent panel, wherein the transparent panel has a first surface and a second surface, and the first surface is opposite the second surface;
providing at least one light source, wherein the light source is disposed at one end of the transparent panel and positioned between the first surface and the second surface, and light rays emitted from the light source are inputted into the transparent panel; and
coating a reflective layer on the first surface of the transparent panel, wherein the reflective layer has an artistic pattern, and the light rays inputted into the transparent panel are reflected by the reflective layer and outputted through the second surface, such that a lighting pattern corresponding to the artistic pattern is formed on the second surface of transparent panel.

19. The method according to claim 1, wherein the reflective layer is coated by a printing machine, and the artistic pattern of the printing machine is predetermined by an inputted picture, and the inputted picture is inputted into the printing machine before coating the reflective layer on the first surface of the transparent panel.

20. An artistic lighting module for a vehicle or a building, comprising:
at least one transparent panel having a first surface and a second surface, wherein the first surface is opposite the second surface;
at least one light source disposed at one end of the transparent panel and positioned between the first surface and the second surface, wherein light rays emitted from the light source are inputted into the transparent panel; and
a reflective layer coated on the first surface of the transparent panel, wherein the reflecting layer has an artistic pattern, and the light rays inputted into the transparent panel are reflected by the reflective layer and outputted through the second surface, such that a lighting pattern corresponding to the artistic pattern is formed on the second surface of transparent panel, and the artistic pattern of the reflective layer comprises words, a mark, a trademark, and/or an indication sign;
wherein the light source and a power source are embedded in a frame or a wall of the building or vehicle, and only the first surface and the second surface of the transparent panel are exposed outside.
